(19) United States
(12) Patent Application Publication
(10) Pub. No.: US 2026/0151935 A1
(43) Pub. Date: Jun. 4, 2026

(54) CONCRETE MIXER VEHICLE WITH AUTONOMOUS SLUMP CHECK

(71) Applicant: Oshkosh Corporation, Oshkosh, WI (US)

(72) Inventors: Eric Wall, Oshkosh, WI (US); Zachary Schoen, Oshkosh, WI (US); Chris Klassanos, Oshkosh, WI (US)

(21) Appl. No.: 19/060,635

(22) Filed: Feb. 22, 2025

Related U.S. Application Data
(60) Provisional application No. 63/556,598, filed on Feb. 22, 2024.

(51) Int. Cl. B28C 5/42; B60P 3/16

(52) U.S. Cl. CPC B28C 5/422; B60P 3/16

(57) ABSTRACT

A concrete mixer truck includes a chassis, an engine, a mixing drum supported on the chassis, a motor configured to rotate the mixing drum, a slump sensor configured to measure a pressure correlated with a slump of a mixture within the mixing drum, and a controller in communication with the engine, the motor, and the slump sensor. The controller is configured to verify an interlock criteria is satisfied, receive an initiate command for a slump check procedure, in response to receiving the initiate command, command the motor to a slump check state, measure the pressure from the slump sensor for a predetermined amount of time, and average the pressure over the predetermined amount of time to produce a slump value.

### CROSS-REFERENCE TO RELATED PATENT APPLICATIONS

This applications claims the benefit of and priority to U.S. Provisional Patent Application No. 63/556,598, filed Feb. 22, 2024, which is incorporated herein by reference in its entirety.

### BACKGROUND

Concrete mixer vehicles are configured to receive, mix, and transport wet concrete or a combination of ingredients that when mixed form wet concrete to a job site. Concrete mixer vehicles include a rotatable mixing drum that receives concrete poured from vehicles or from stationary facilities, such as concrete mixing plants, and mixes the concrete disposed therein.

### SUMMARY

At least one embodiment relates to a concrete mixer truck. The concrete mixer truck includes a chassis, an engine, a mixing drum supported on the chassis, a motor configured to rotate the mixing drum, a slump sensor configured to measure a pressure correlated with a slump of a mixture within the mixing drum, and a controller in communication with the engine, the motor, and the slump sensor. The controller is configured to verify an interlock criteria is satisfied, receive an initiate command for a slump check procedure, in response to receiving the initiate command, command the motor to a slump check state, measure the pressure from the slump sensor for a predetermined amount of time, and average the pressure over the predetermined amount of time to produce a slump value.

At least one embodiment relates to a concrete mixer truck. The concrete mixer truck includes a chassis, an engine, a mixing drum supported on the chassis, a motor configured to rotate the mixing drum, a slump sensor configured to measure a pressure correlated with a slump of a mixture within the mixing drum, a user interface, and a controller in communication with the engine, the motor, the slump sensor, and the user interface. The controller is configured to receive an initiate command from the user interface for a slump check procedure, verify an interlock criteria is satisfied, in response to the interlock criteria being satisfied, initiate the slump check procedure and command the motor to a slump check state, average the pressure from the slump sensor for a predetermined amount of time, and calculate a slump value based on the average of the pressure measured by the slump sensor.

At least one embodiment relates to a method for an autonomous slump check procedure on a concrete mixer truck. The method includes receiving, from a user interface, an initiate command, verifying an interlock criteria is satisfied, in response to verifying that the interlock criteria is satisfied, and initiating a slump check procedure by: commanding a motor to a slump check state, averaging the pressure from a slump sensor for a predetermined amount of time, and calculating a slump value based on the average of the pressure measured by the slump sensor over the predetermined amount of time.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a side view of a concrete mixer truck, according to an exemplary embodiment;

FIG. 2 is a front perspective view of the concrete mixer truck of FIG. 1, according to an exemplary embodiment;

FIG. 3 is a rear perspective view of the concrete mixer truck of FIG. 1, according to an exemplary embodiment;

FIG. 4 is a block diagram of a control system of a concrete mixer vehicle, according to an exemplary embodiment;

FIG. 5 is a flowchart illustrating the steps in a slump check procedure or method, according to an exemplary embodiment;

FIG. 6 shows a user interface of a concrete mixer vehicle, according to an exemplary embodiment;

FIG. 7 shows a concrete management screen of the user interface of FIG. 6, according to an exemplary embodiment;

FIG. 8 shows a slump information screen of the user interface of FIG. 6, according to an exemplary embodiment;

FIG. 9 shows a secondary slump information screen of the user interface of FIG. 6, according to an exemplary embodiment;

FIGS. 10A-D shows various views of a slump check screen of the user interface of FIG. 6, according to an exemplary embodiment;

FIG. 11 shows a slump history screen of the user interface of FIG. 6, according to an exemplary embodiment;

FIG. 12 shows a slump check screen after of the user interface of FIG. 6 after a failed slump check procedure, according to an exemplary embodiment;

FIG. 13 shows a slump meter screen of the user interface of FIG. 6, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Slump measurements or checks on a concrete mixer truck/vehicle are typically based on a pressure measurement that corresponds with an amount of pressure required to spin the mixing drum on the concrete mixer vehicle. There are several variables that may have an effect on the slump measurement (e.g., drum speed, etc.), so operators are usually instructed to perform a slump measurement at a particular set of operating conditions. But this methodology is subject to the accuracy with which the operators perform the slump measurement and introduces the potential for operator error.

The systems and methods of the present disclosure provide an autonomous slump check procedure on a concrete mixer vehicle that performs the slump measurement repeatably without requiring operator control. According to some embodiments, the concrete mixer vehicle includes a controller that is in communication with a user interface and, in response to initiating a slump check procedure via the user interface, the controller is configured to perform one or more automated steps to measure the slump. In some embodiments, prior to initiating the slump check procedure, the controller may verify that one or more interlock criteria are met. If the interlock criteria are not met, the controller may disable a start button on the user interface. If the interlock criteria are met, the start button is activated on the user interface. Upon initiating the slump check procedure, the controller may autonomously set the mixing drum to a slump check state, measure the slump based on a slump sensor (e.g., a slump pressure sensor), and record the slump value in a table that is visible in the user interface.

In some embodiments, the slump check state is achieved by providing a fixed input to a drum motor (e.g., a hydraulic motor or an electric motor). In some embodiments, the slump check state is achieved by the controller setting a pump to a predetermined displacement and setting the drum motor to a predetermined displacement. In some embodiments, the slump check state is achieved by the controller supplying a predetermined amount of electrical power or current to the drum motor. Regardless of the particular implementation of the slump check state, by keeping the input to the drum motor fixed, the slump check procedure is consistent and repeatable, and the autonomous control of the slump check procedure removes operator error.

### Overall Vehicle

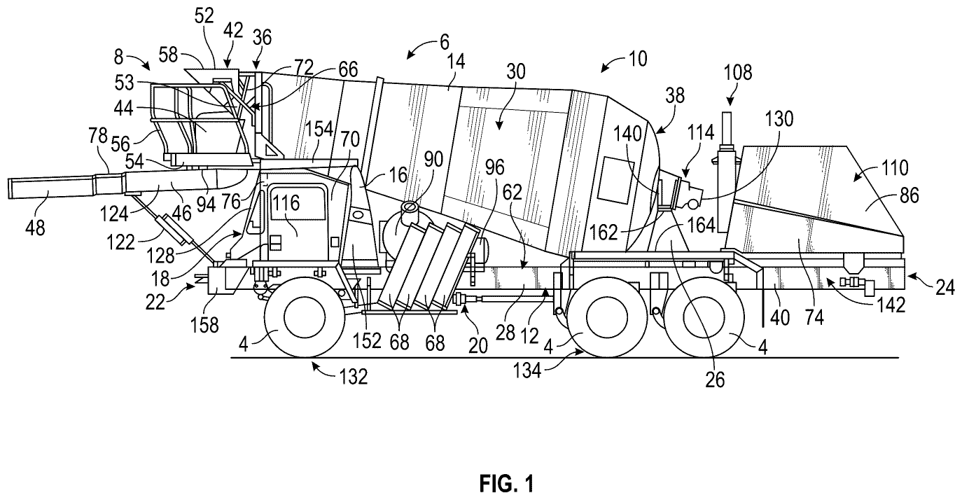

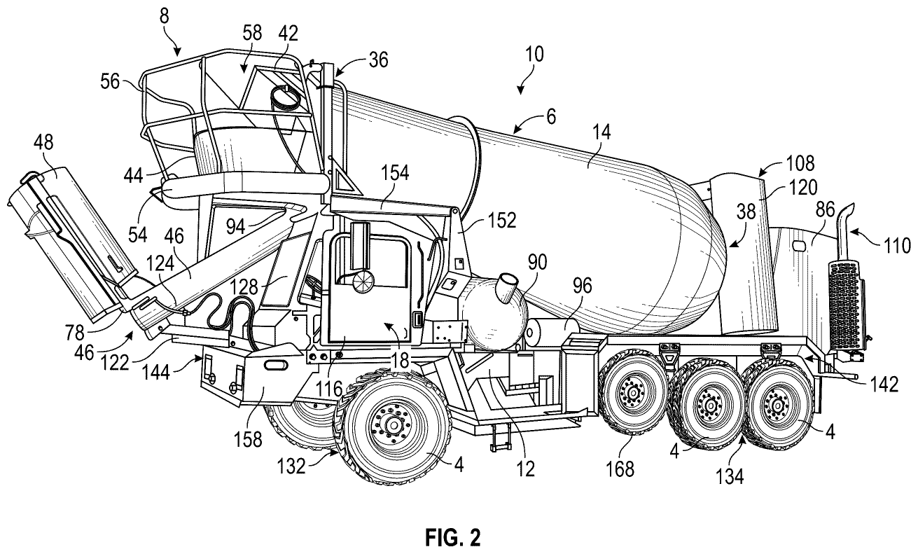

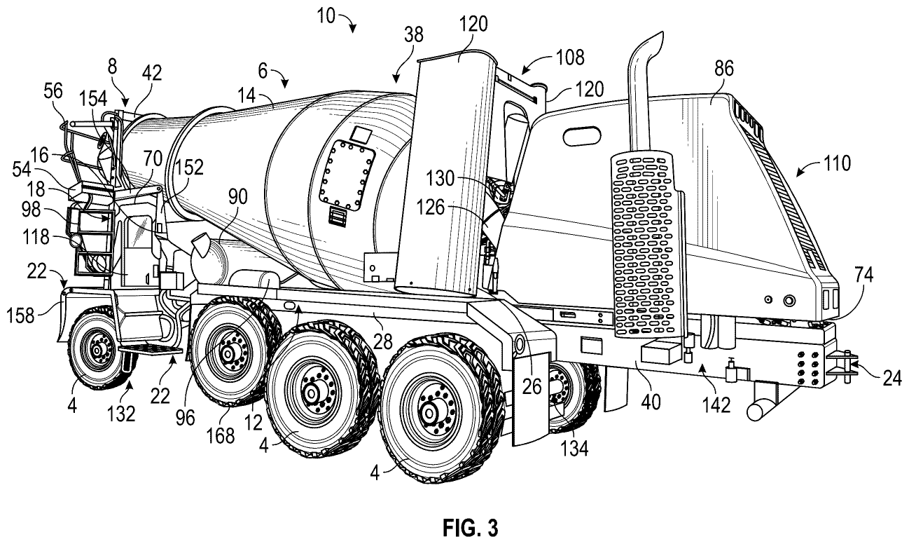

According to the exemplary embodiment shown in FIGS. 1-3, a vehicle, shown as concrete mixer truck 10, is configured to transport concrete from a loading location (e.g., a batching plant, etc.) to a point of use (e.g., a worksite, a construction site, etc.). In some embodiments, as shown in FIGS. 1-3, the concrete mixer truck 10 is a front discharge concrete mixer vehicle. In other embodiments, the concrete mixer truck 10 is a rear discharge concrete mixer vehicle. The concrete mixer truck 10 includes a chassis 12, a drum assembly 6, a hopper assembly 8, a drive system 20, a fuel system 108, and an engine module 110. The concrete mixer truck 10 may include various additional engine, transmission, drive, electronic, tractive assembly, braking, steering and/or suspension systems, and hydraulic systems that are configured to support the various components of the concrete mixer truck 10. Generally, the chassis 12 supports a mixing drum 14 of the drum assembly 6, a front pedestal 16, a rear pedestal 26, a cab 18, and the engine module 110. Each of the chassis 12, the drum assembly 6, the hopper assembly 8, the drive system 20, the fuel system 108, and the engine module 110 are configured to facilitate receiving, mixing, transporting, and delivering concrete to a job site via the concrete mixer truck 10.

The chassis 12 includes a frame 28 that extends from a front end 22 to a rear end 24 of the concrete mixer truck 10. Wheels 4 are coupled to the frame 28 and moveably support the frame 28 above a ground surface or road. The wheels 4 may be replaced by other ground engaging motive members, such as tracks. In some embodiments, the chassis 12 includes hydraulic components (e.g., valves, filters, pipes, hoses, etc.) coupled thereto that facilitate operation and control of a hydraulic circuit including a drum drive pump and/or an accessory pump. The frame 28 provides a structural base for supporting the mixing drum 14, the front pedestal 16, the rear pedestal 26, the cab 18, and the engine module 110. In some embodiments, the frame 28 includes a widened front portion that extends over and about the wheels 4 positioned at the front end 22 of the chassis 12 to simultaneously support the cab 18 and serve as a fender for the wheels 4 positioned at the front end 22 of the chassis 12. The frame 28 may include lift eyes or other structures that facilitates lifting along the chassis 12 such that the chassis 12 can be manipulated as a subassembly for assembly and/or maintenance of the concrete mixer truck 10. One or more components may be coupled to the chassis 12 using isolating mounts made of a complaint material, such as rubber. The isolating mounts may be configured to reduce the transfer of vibrations between the components and the chassis 12.

The frame 28 includes a pair of frame rails 40 coupled with intermediate cross members, according to an exemplary embodiment. The frame rails 40 extend in a generally-horizontal and longitudinal direction (e.g., extend within 10 degrees of perpendicular relative to a vertical direction, extend within ten degrees of parallel relative to a ground surface when concrete mixer truck 10 is positioned on flat ground, etc.) between the front end 22 and the rear end 24. The frame rails 40 may be elongated “C-channels” or tubular members, according to various exemplary embodiments. In other embodiments, the frame rails 40 include another type of structural element (e.g., monocoque, a hull, etc.). In still other embodiments, the frame rails 40 include a combination of elongated C-channels, tubular members, a monocoque element, and/or a hull element. A first frame rail 40 may be disposed along a first lateral side 142 and a second frame rail 40 may be disposed along a second lateral side 144, respectively, of the concrete mixer truck 10. By way of example, the first lateral side 142 of the chassis 12 may be the left side of the concrete mixer truck 10 (e.g., when an operator is sitting in the cab 18 and positioned to drive the concrete mixer truck 10, etc.) and the second lateral side 144 of the chassis 12 may be the right side of the concrete mixer truck 10 (e.g., when an operator is sitting in the cab 18 and positioned to drive the concrete mixer truck 10, etc.).

The cab 18 is coupled to the frame rails 40 proximate the front end 22 of the chassis 12. According to various embodiments, the cab 18 (e.g., operator cabin, front cabin, etc.) is configured to house one or more operators during operation of the concrete mixer truck 10 (e.g., when driving, when dispensing concrete, etc.), and may include various components that facilitate operation and occupancy of the concrete mixer truck 10 (e.g., one or more seats, a steering wheel, control panels, screens, joysticks, buttons, accelerator, brake, gear lever, etc.). The cab 18 includes a housing 70 that forms the structure of the cab 18. At least one door 116 is affixed to the housing 70 to allow an operator to enter and exit the cab 18. A windshield 128 is disposed along a front side of the housing 70, near the front end 22, and above a front bumper 158 of the concrete mixer truck 10. The windshield 128 is configured to provide visibility to the operator while driving the concrete mixer truck 10, operating a main chute 46, and completing other tasks. The front bumper 158 may be affixed to a bottom portion of the housing 70. In some embodiments, the front bumper 158 is affixed to the frame 28 at the front end 22 of the concrete mixer truck 10.

A control assembly 76 is disposed within the cab 18 and is configured to control one or more components of the concrete mixer truck 10. The control assembly 76 may include controls, buttons, joysticks, and other features that control the movement and orientation of the concrete mixer truck 10, the hopper assembly 8, the main chute 46, a charge hopper 42, a discharge hopper 44, the mixing drum 14, and/or other components of the concrete mixer truck 10. For example, the control assembly 76 may include overhead controls (e.g., in a forward overhead position) that allow an occupant of the cab 18 to toggle a switch from a ‘Close’ position to an ‘Open’ position to open and close the charge hopper 42 and/or the discharge hopper 44. In some embodiments, the control assembly 76 includes a user interface with a display and an operator input. The display may be configured to display a graphical user interface, an image, an icon, or still other information. In one embodiment, the display includes a graphical user interface configured to provide general information about the concrete mixer truck 10 (e.g., vehicle speed, fuel level, warning lights, etc.). The graphical user interface may also be configured to display a current mode of operation, various potential modes of operation, or still other information relating to a transmission, modules, the drive system 20, and/or other components of the concrete mixer truck 10.

An air tank 96 is coupled to and supported by the chassis 12 and positioned directly beneath the mixing drum 14. The air tank 96 is configured to store compressed air (e.g., for use in an air brake system, for use when raising and lowering a pusher axle assembly, etc.). A water tank 90 extends laterally across the length of the chassis 12, forward of the air tank 96. The water tank 90 is coupled to the frame rails 40 and positioned beneath the mixing drum 14. The water tank 90 may be coupled to a water pump that is used to supply water from the water tank 90 to wash the concrete mixer truck 10 after pouring a concrete load and/or to add water to the concrete within the mixing drum 14 at the construction site and/or during transit, among other uses.

The drum assembly 6 is configured to store, mix and dispense concrete. The drum assembly 6 includes the mixing drum 14, a drum driver 114, and the hopper assembly 8. The mixing drum 14 extends longitudinally along a majority of the length of concrete mixer truck 10 and may be angled relative to the frame rails 40 (e.g., when viewed from the side of concrete mixer truck 10). The mixing drum 14 has a first end 36 that is positioned toward the front end 22 of the concrete mixer truck 10 and coupled to the front pedestal 16 (e.g., support post, support column, etc.). The first end 36 may at least partially extend over the cab 18. The first end 36 defines a drum opening 72 in communication with the hopper assembly 8 through which concrete may flow (e.g., between the charge hopper 42, the mixing drum 14, the discharge hopper 44, the main chute 46, and extension chutes 48, etc.). The mixing drum 14 has a second end 38 that is positioned toward the rear end 24 of the concrete mixer truck 10 and coupled to the rear pedestal 26 (e.g., support post, support column, etc.). The mixing drum 14 may be rotatably coupled to front pedestal 16 (e.g., with a plurality of wheels or rollers, etc.) and rear pedestal 26 (e.g., with a drum drive transmission, etc.). Each of the front pedestal 16 and the rear pedestal 26 may be a part of a superstructure of the concrete mixer truck 10. The superstructure further includes the frame 28 and the chassis 12. In other embodiments, the mixing drum 14 is otherwise coupled to the frame rails 40. Although the concrete mixer truck 10 illustrated in FIGS. 1-3 is a front discharge concrete mixer vehicle, it is to be understood that in other embodiments the concrete mixer truck 10 may include a drum assembly 6 having any other discharge arrangement (e.g., rear discharge).

The front pedestal 16 includes an upper portion 152 and a lower portion 154. The upper portion 152 is coupled to and supports the hopper assembly 8. The lower portion 154 is coupled to the frame rails 40 and supports the upper portion 152 of the front pedestal 16 and the first end 36 of the mixing drum 14. The rear pedestal 26 includes an upper portion 162 and a lower portion 164. The lower portion 164 is coupled to the frame rails 40 and supports the upper portion 162. The upper portion 162 supports a bottom interface of a drum drive transmission 140 (e.g., a bottom portion of the housing thereof) and/or the second end 38 of the mixing drum 14. In some embodiments, the rear pedestal 26 includes a pair of legs extending between the frame rails 40 and the drum drive transmission 140.

The drum opening 72 at the first end 36 of the mixing drum 14 is configured to receive a mixture, such as a concrete mixture, or mixture ingredients (e.g., cementitious material, aggregate, sand, etc.) such that the mixture can enter and exit an internal volume 30 of the mixing drum 14. The mixing drum 14 may include a mixing element (e.g., fins, etc.) positioned within the internal volume 30. The mixing element may be configured to (i) agitate the contents of mixture within the mixing drum 14 when the mixing drum 14 is rotated in a first direction (e.g., counterclockwise, clockwise, etc.) and (ii) drive the mixture within the mixing drum 14 out through the drum opening 72 when the mixing drum 14 is rotated in an opposing second direction (e.g., clockwise, counterclockwise, etc.). During operation of the concrete mixer truck 10, the mixing elements of the mixing drum 14 are configured to agitate the contents of a mixture located within the internal volume 30 of the mixing drum 14 as the mixing drum 14 is rotated in a counterclockwise and/or a clockwise direction by the drum driver 114.

The drum driver 114 is configured to provide an input (e.g., a torque, etc.) to the mixing drum 14 to rotate the mixing drum 14 relative to the chassis 12. The drum driver 114 may be configured to selectively rotate the mixing drum 14 clockwise or counterclockwise, depending on the mode of operation of the concrete mixer truck 10 (i.e., whether concrete is being mixed or dispensed). The drum driver 114 is coupled to a rear or base portion of the second end 38 of the mixing drum 14 and a top end of the lower portion 164 and/or a lower end of the upper portion 162 of the rear pedestal 26. The drum driver 114 includes a transmission, shown as drum drive transmission 140, and a driver, shown as drum drive motor 130, coupled to drum drive transmission 140. The drum drive transmission 140 extends rearward (e.g., toward the rear end 24 of the concrete mixer truck 10, toward the engine module 110, etc.) from the second end 38 of mixing drum 14 and the drum drive motor 130 extends rearward from drum drive transmission 140. In some embodiments, the drum drive motor 130 is a hydraulic motor. In other embodiments, the drum drive motor 130 is another type of actuator (e.g., an electric motor, etc.). The drum drive motor 130 is configured to provide an output torque to the drum drive transmission 140, according to an exemplary embodiment, which rotates the mixing drum 14 about a rotation axis. The drum drive transmission 140 may include a plurality of gears (e.g., a planetary gear reduction set, etc.) configured to increase the turning torque applied to the mixing drum 14, according to an exemplary embodiment. The plurality of gears may be disposed within a housing. In some embodiments, a drum drive pump and/or accessory pump may be configured to receive rotational mechanical energy and output a flow of pressurized hydraulic fluid to drive one or more components of the concrete mixer truck 10.

The hopper assembly 8 is positioned at the drum opening 72 of the mixing drum 14. The hopper assembly 8 is configured to introduce materials into and allow the materials to flow out of the internal volume 30 of the mixing drum 14 of the concrete mixer truck 10. The hopper assembly 8 is configured to prevent loss of material or spillage when the material enters and exits the mixing drum 14. The hopper assembly 8 includes the charge hopper 42, the discharge hopper 44, a hopper actuator 66, a platform 54, and the main chute 46, which are positioned above at least partially forward of the cab 18 of the concrete mixer truck 10. The charge hopper 42 is configured to direct the materials (e.g., cement precursor materials, etc.) into the drum opening 72 of the mixing drum 14. The discharge hopper 44 is configured to dispense mixed concrete from the internal volume 30 of the mixing drum 14 to the main chute 46 and, ultimately, the desired location.

The platform 54 includes a perforated surface that surrounds the charge hopper 42 and the discharge hopper 44. In some embodiments, the platform 54 includes an asymmetric base. The platform 54 includes platform sides extending beneath the perforated surface. A guardrail 56 is coupled to the platform 54 and follows the contour of a periphery of the platform 54. The platform 54 is situated at a position near the drum opening 72 of the mixing drum 14 to facilitate access by the operator to the drum opening 72, the internal volume 30, the charge hopper 42, the discharge hopper 44, and/or the main chute 46. In some embodiments, the concrete mixer truck 10 includes a ladder 98 that extends downward from a side of the platform 54 to allow an operator to climb and reach the platform 54.

The charge hopper 42 includes a first portion 52 that is configured to receive materials during a charging/loading operation. The first portion 52 has a rim 58 (e.g., opening) formed at a free end of the first portion 52. The charge hopper 42 includes a second portion 53 aligned with the bottom of the first portion 52. According to an exemplary embodiment, the charge hopper 42 is selectively repositionable/movable. In some embodiments, the charge hopper 42 is configured to rotate about a horizontal, lateral axis. In some embodiments, the charge hopper 42 is configured to raise and lower vertically. Specifically, the charge hopper 42 is configured to lift, pivot, or otherwise move between a first position (e.g., a lowered position, loading position, a charging position, etc.) and a second position (e.g., a raised position, a dispensing/discharging position, a pivoted position, etc.) above or shifted from the first position. In the first position, the charge hopper 42 is configured to direct material (e.g., concrete, etc.) from a source positioned above the concrete mixer truck 10 (e.g., a batch plant, etc.) through the drum opening 72 and into the internal volume 30 of the mixing drum 14. The first position may also facilitate transport of the concrete mixer truck 10 by lowering the overall height of the concrete mixer truck 10. In the second position, the charge hopper 42 moves (e.g., lifts, pivots, etc.) away from the drum opening 72 and facilitates material flowing unobstructed out of the drum opening 72 and into the discharge hopper 44 and the main chute 46.

A hopper actuator 66 is positioned to move the charge hopper 42 between the first position and the second position. The hopper actuator 66 facilitates selectively controlling movement of the charge hopper 42 between the first position and the second position. The hopper actuator 66 is coupled to and extends between the charge hopper 42 and the platform 54. In some embodiments, the hopper actuator 66 is a hydraulic cylinder. In other embodiments, the hopper actuator 66 is another type of actuators (e.g., a pneumatic cylinder, a lead screw driven by an electric motor, an electric motor, etc.).

When receiving the material, the charge hopper 42 may be in the first position and the main chute 46 may be in a first configuration (e.g., a transport configuration, a stored configuration, etc.). Accordingly, material can be deposited into the charge hopper 42, and the charge hopper 42 directs the material into the internal volume 30 of the mixing drum 14 through the drum opening 72. While material is being added to the mixing drum 14, the drum driver 114 may be operated to drive the mixing drum 14 to agitate the material and facilitate fully loading/packing the mixing drum 14. Alternatively, the mixing drum 14 may be stationary while material is added to the mixing drum 14. When discharging and the charge hopper 42 is in the second position, the discharge hopper 44 funnels material from the mixing drum 14 into the main chute 46.

The main chute 46 functions as an outlet of the mixing drum 14 and is used to direct concrete dispensed from the internal volume 30 of the mixing drum 14 and through the discharge hopper 44 to a target location near the concrete mixer truck 10. The main chute 46 is pivotally coupled to the platform 54 and/or the discharge hopper 44 such that the main chute 46 is configured to rotate about both a vertical axis and a horizontal axis. The main chute 46 includes a base section 124 that may be pivotally coupled to the platform 54 and/or the discharge hopper 44. An extension chute 48 (e.g., a folding section, a second chute section, etc.) is pivotally coupled to the distal end of the base section 124. In some embodiments, a plurality of extension chutes 48 are pivotally connected to one another. One or more removable/detachable extension chutes 68 may be selectively coupled to the distal end of the extension chute 48. The main chute 46 is selectively reconfigurable between a first configuration (e.g., a storage configuration, a transport configuration, etc.) and a second configuration (e.g., a use configuration, a dispensing configuration, etc.). In the first configuration, (i) the base section 124 may be selectively oriented substantially horizontal and extending laterally outward, (ii) the extension chute 48 may be selectively pivoted relative to the base section 124 and extending substantially vertically, and (iii) the removable extension chutes 68 may be removed from the extension chute 48 and stored elsewhere in the concrete mixer truck 10 (e.g., coupled to the chassis 12 beneath the mixing drum 14, etc.). In the first configuration, the main chute 46 may, therefore, minimally obscure the view of an operator positioned within the cab 18. In the second configuration, (i) the extension chute 48 may be pivoted relative to the base section 124 from the substantially vertical orientation to a substantially horizontal orientation such that the base section 124 and the extension chute 48 are aligned with one another to form a continuous path through which material can flow, and (ii) one or more of the removable extension chutes 68 may be coupled to the distal end of the extension chute 48 to increase the length of the main chute 46 (e.g., to distribute concrete further away from the concrete mixer truck 10, etc.).

A first chute actuator 122 (e.g., a chute raising/lowering actuator, etc.) is coupled to and extends between the main chute 46 (e.g., a distal end thereof, etc.) and the chassis 12. In some embodiments, the first chute actuator 122 is extends between the main chute 46 and the front bumper 158. The first chute actuator 122 is configured to raise and lower the main chute 46 to control the orientation of the main chute 46 relative to a horizontal plane (e.g., the ground, etc.). In some embodiments, the first chute actuator 122 is a pair of opposing hydraulic cylinders. In other embodiments, the first chute actuator 122 is another type of actuator (e.g., a pneumatic cylinder, a lead screw driven by an electric motor, a single hydraulic cylinder, etc.). In some embodiments, the first chute actuator 122 and the main chute 46 are both configured to rotate about the same or substantially the same vertical axis (e.g., as the main chute 46 is pivoted about the vertical axis as described in more detail herein).

A second chute actuator 94 (e.g., a chute pivot/rotation actuator, etc.) is coupled to the base section 124 of the main chute 46 and the platform 54. The second chute actuator 94 is configured to rotate the main chute 46 about a vertical axis. The second chute actuator 94 is configured to move the distal end of the main chute 46 through an arc along the left, front, and right sides of the chassis 12 (e.g., a 150 degree arc, a 180 degree arc, a 210 degree arc, etc.). In one embodiment, the second chute actuator 94 is a hydraulic motor. In other embodiments, the second chute actuator 94 is another type of actuator (e.g., a pneumatic motor, an electric motor, etc.).

A third chute actuator 78 (e.g., a chute folding/unfolding actuator, etc.) is configured to reposition (e.g., extend and retract, fold and unfold, etc.) the extension chute 48 relative to the base section 124 of the main chute 46. The third chute actuators 78 may be coupled to and extend between the base section 124 and the extension chute 48. In some embodiments, the third chute actuator 78 includes a plurality of actuators positioned to reposition a first extension chute 48 relative to the base section 124 and one or more second extension chutes 48 relative to the first extension chute 48. The first chute actuator 122, the second chute actuator 94, and the third chute actuator 78 facilitate selectively reconfiguring the main chute 46 between the first configuration and the second configuration. In some embodiments, a controller (e.g., joystick) is configured to facilitate providing commands to control operation of the first chute actuator 122, the second chute actuator 94, and the third chute actuator 78 to direct the main chute 46 and concrete flow therefrom. In some embodiments, a hopper pump may be coupled to the chassis 12 and configured to provide pressurized hydraulic fluid to power the first chute actuator 122, the second chute actuator 94, and/or the third chute actuator 78. The hopper pump may be a variable displacement pump or a fixed displacement pump. Additionally or alternatively, a pneumatic pump and/or an electrical storage and/or generation device is used to power one or more of the first chute actuator 122, the second chute actuator 94, and/or the third chute actuator 78.

Once at the job site, the concrete mixer truck 10 may be configured to dispense the material to a desired location (e.g., into a form, onto the ground, etc.). The charge hopper 42 may be repositioned into the second position from the first position by the hopper actuator 66. The extension chute(s) 48 may be extended by the third chute actuator(s) 78 to reconfigure the main chute 46 into the second configuration from the first configuration. An operator can then couple one or more removable extension chutes 68 to the distal end of the extension chute 48 to increase the overall length of the main chute 46 (as necessary). Once the main chute 46 is in the second configuration, the operator can control the first chute actuator 122 and/or the second chute actuator 94 to adjust the orientation of the main chute 46 (e.g., about a vertical axis, about a lateral axis, etc.) and thereby direct the material onto the desired location. Once the main chute 46 is in the desired orientation, the operator can control the drum driver 114 to rotate the mixing drum 14 in the second direction, expelling the material through the drum opening 72, into the discharge hopper 44, and into the main chute 46. The operator may control the speed of the mixing drum 14 to adjust the rate at which the material is delivered through the main chute 46. Throughout the process of dispensing the material, the operator can change the location onto which the material is dispensed by varying the orientation of the main chute 46 and/or by controlling the drive system 20 to propel/move the concrete mixer truck 10.

The drive system 20 is configured to propel the concrete mixer truck 10 and may drive other systems of the concrete mixer truck 10 (e.g., the drum driver 114, etc.). The drive system 20 includes driven tractive assemblies that include a front axle assembly 132 and a pair of rear axle assemblies 134, each coupled to various wheels 4. In some embodiments, the drive system 20 includes a driveshaft coupled to the front axle assembly 132 and/or the rear axle assemblies 134. The front axle assembly 132 and the rear axle assemblies 134 are coupled to the power plant module 62 through the drive system 20 such that the front axle assembly 132 and the rear axle assemblies 134 at least selectively receive mechanical energy (e.g., rotational mechanical energy) and propel the concrete mixer truck 10. In some embodiments, a pusher axle assembly 168 (e.g., tag axle assembly, etc.) is configured to be raised and lowered to selectively engage the support surface (e.g., based on the loading of the concrete mixer truck 10, etc.). Such a configuration distributes the pressure exerted on the ground by the concrete mixer truck 10, which may be required, for example, when traveling through certain municipalities under load.

The power plant module 62 (e.g., prime mover module, driver module, etc.) is configured to supply rotational mechanical energy to drive the concrete mixer truck 10. The power plant module 62 is coupled to the chassis 12 and positioned near the longitudinal center of the concrete mixer truck 10, beneath the mixing drum 14. According to an exemplary embodiment, the power plant module 62 receives a power input from the engine module 110. In some embodiments, the power plant module 62 includes a transmission and/or an electromagnetic device (e.g., an electrical machine, a motor/generator, etc.) coupled to the transmission. In some embodiments, the transmission and the electromagnetic device are integrated into a single device (e.g., an electromechanical infinitely variable transmission, an electromechanical transmission, etc.). The electromagnetic device is configured to provide a mechanical energy input to the transmission. By way of example, the electromagnetic device may be configured to supply a rotational mechanical energy input to the transmission (e.g., using electrical energy generated from the mechanical power input provided by the engine module 110, etc.). In some embodiments, the power plant module 62 and/or the drive system 20 includes additional pumps (hydraulic fluid pumps, water pumps, etc.), compressors (e.g., air compressors, air conditioning compressors, etc.), generators, alternators, and/or other types of energy generation and/or distribution devices configured to transfer the energy from the power plant module 62 to other systems.

The fuel system 108 is configured to provide fuel to the engine module 110 and/or other components of the concrete mixer truck 10. Specifically, the fuel system 108 may be configured to provide fuel to an engine 74 of the engine module 110. The engine 74 may use the fuel in an internal combustion process to generate a mechanical power output that is provided to the power plant module 62 (e.g., to generate electricity, to power onboard electric motors used to at least one of rotate wheel and tire assemblies, to drive the transmission etc.) and/or to power the drum driver 114. The fuel system 108 may include one or more valves, hoses, regulators, filters, and/or various other components configured to facilitate providing fuel to the engine 74. The fuel system 108 includes a container 126 (e.g., a vessel, reservoir, tank, etc.) that is configured to store a fluid (e.g., fuel, air, hydraulic fluid, etc.). The container 126 is disposed behind the drum driver 114 along the chassis 12. In other embodiments, the container 126 is coupled to a side of the rear pedestal 26. In some embodiments, the container 126 is coupled to the chassis 12 and positioned directly beneath the mixing drum 14. According to an exemplary embodiment, the container 126 includes a fuel tank that stores fuel used to power the engine 74. In some embodiments, the container 126 additionally or alternatively includes an air tank configured to store compressed air (e.g., for use in an air brake system, for use when raising and lowering the pusher axle assembly 168, etc.). In some embodiments, the container 126 additionally or alternatively includes a hydraulic tank configured to store hydraulic fluid for use in one or more hydraulic circuits (e.g., a hydraulic circuit that includes the drum driver 114, etc.).

A cover assembly 120 including a plurality of cover panels is positioned between the second end 38 of the mixing drum 14 and the engine module 110. The cover assembly 120 is disposed around the fuel system 108 (e.g., the container 126, etc.), the drum driver 114, and the rear pedestal 26. The cover assembly 120 is configured to protect the various internal components from debris. Such debris may be encountered while the concrete mixer truck 10 is driven along a roadway, for example. The cover assembly 120 may also protect the various internal components from damage due to collisions with trees, poles, or other structures at a jobsite or while transporting concrete. In some embodiments, all or some of the fuel system 108 is incorporated under a hood 86 of the engine module 110.

The engine module 110 is coupled to the frame rails 40 proximate the rear end 24 of the chassis 12. The engine module 110 is configured to directly, or indirectly, supply the various components of the concrete mixer truck 10 with the power needed to operate the concrete mixer truck 10. By way of example, the engine module 110 may be configured to provide mechanical energy (e.g., rotational mechanical energy) (i) to one or more components directly (e.g., via a power-take-off, etc.) to drive the one or more components (e.g., a hydraulic pump of the drum driver 114, etc.) and/or (ii) to the power plant module 62 to drive the one or more components indirectly. The engine module 110 may be defined by any number of different types of power sources. According to an exemplary embodiment, the engine module 110 includes the engine 74 coupled to the frame rails 40 and disposed within the hood 86. The engine 74 may include an internal combustion engine configured to utilize one or more of a variety of fuels (e.g., gasoline, diesel, bio-diesel, ethanol, natural gas, etc.) to output mechanical energy. In some embodiments, at least one of the drum drive motor 130, the first chute actuator 122, the second chute actuator 94, and the third chute actuator 78 is electrically driven (i.e., powered using electrical energy) rather than hydraulically driven.

In some embodiments, the engine module 110 additionally or alternatively includes multiple battery modules (e.g., batteries, capacitors, ultra-capacitors, etc.) spread throughout the concrete mixer truck 10, which cooperate to act collectively as an energy storage device. The engine module 110 can be charged through an onboard energy source (e.g., through use of an onboard generator powered by an internal combustion engine, by operating the electromagnetic device as a generator, during regenerative braking, through an onboard fuel cell, through an onboard solar panel, etc.) or through an external energy source (e.g., when receiving mains power from a power grid, etc.). In some embodiments, the concrete mixer truck 10 is a purely electric vehicle that does not include an internal combustion engine and, as such, is driven by electrical energy in all modes of operation. In such embodiments, the concrete mixer truck 10 may not include a fuel tank.

### Autonomous Slump Check

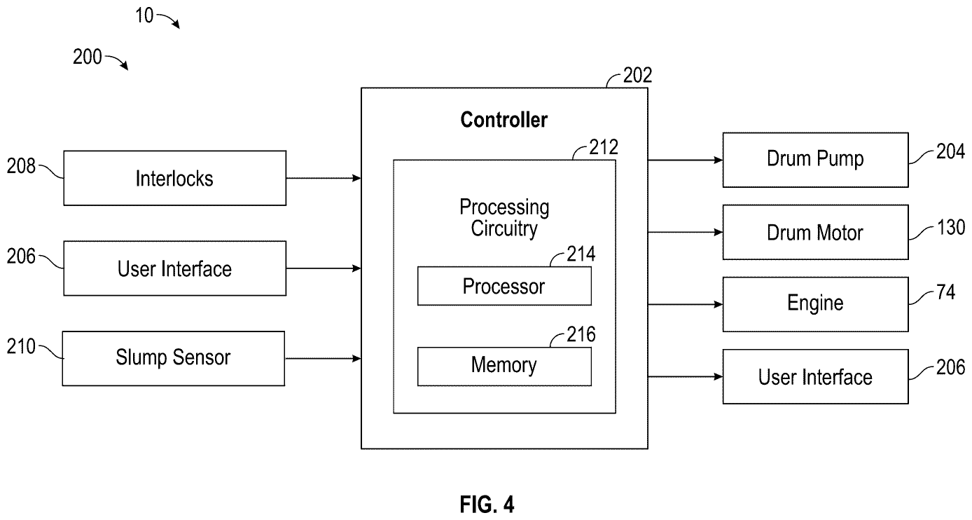

FIG. 4 shows a control system 200 of the concrete mixer truck 10, according to an exemplary embodiment. In some embodiments, the control system 200 may include some or all of the components of the control assembly 76 described herein. In general, the control system 200 includes a controller 202 that is in communication with the engine 74, the drum drive motor 130, a drum drive pump 204, a user interface 206, one or more interlocks 208, and a slump sensor 210. In some embodiments, the controller 202 is a global controller that is in communication with one or more supplemental controllers on the concrete mixer vehicle 10 (e.g., an engine controller, a hydraulic controller, a drum controller, etc.). In some embodiments, the controller 202 is a controller dedicated to controlling operation of the slump check procedure described herein.

The controller 202 includes a processing circuit 212 having a processor 214 and a memory 216. The processor 214 may be coupled to the memory 216. The processor 214 may be a general purpose or specific purpose processor, an application specific integrated circuit (ASIC), one or more field programmable gate arrays (FPGAs), a group of processing components, or other suitable processing components. The processor 214 is configured to execute computer code or instructions stored in the memory 216 or received from other computer readable media (e.g., CDROM, network storage, a remote server, etc.).

The memory 216 may include one or more devices (e.g., memory units, memory devices, storage devices, etc.) for storing data and/or computer code for completing and/or facilitating the various processes described in the present disclosure. The memory 216 may include random access memory (RAM), read-only memory (ROM), hard drive storage, temporary storage, non-volatile memory, flash memory, optical memory, or any other suitable memory for storing software objects and/or computer instructions. The memory 216 may include database components, object code components, script components, or any other type of information structure for supporting the various activities and information structures described in the present disclosure. The memory 216 may be communicably connected to the processor 214 via the processing circuit 212 and may include computer code for executing (e.g., by the processor 214) one or more of the processes described herein.

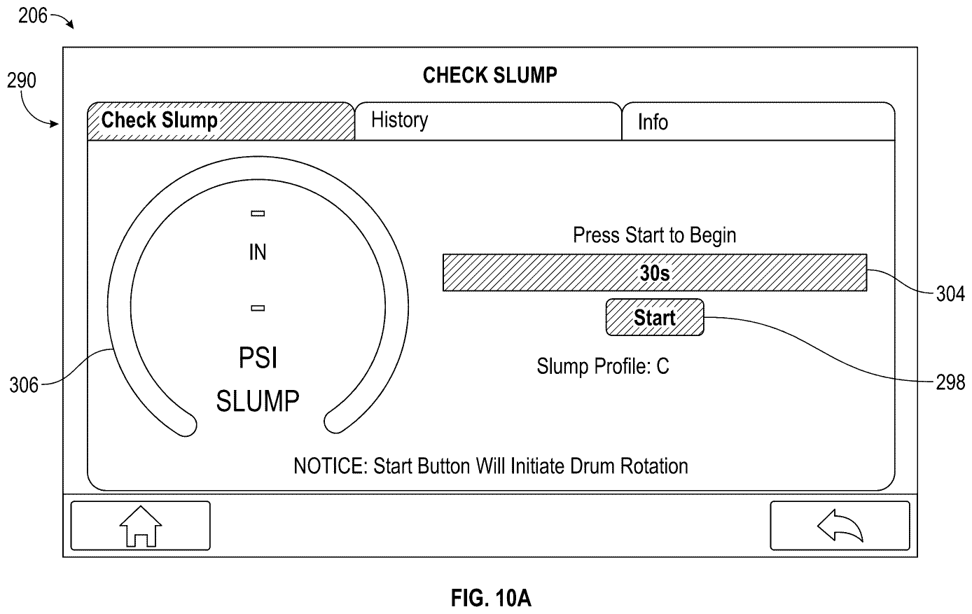

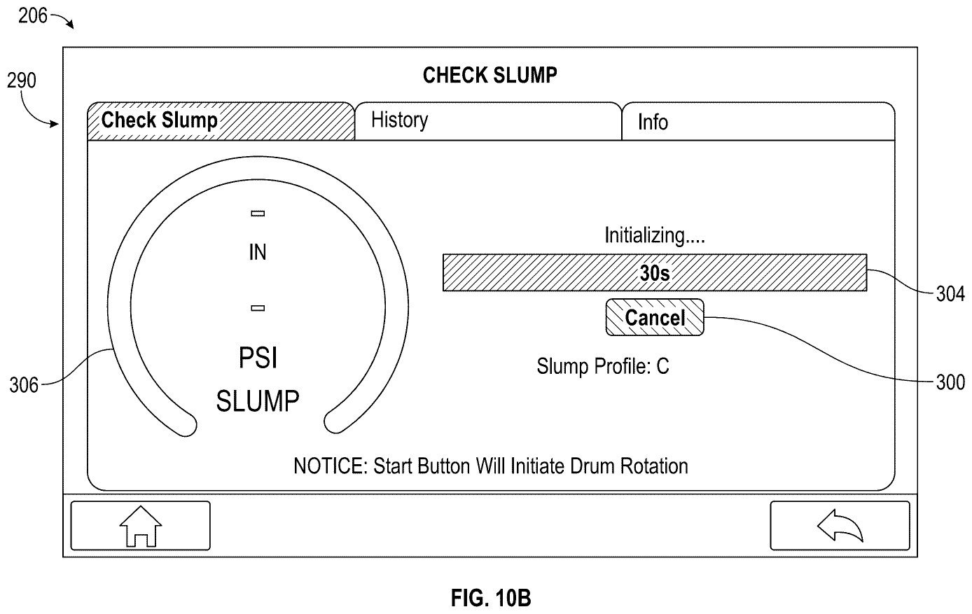

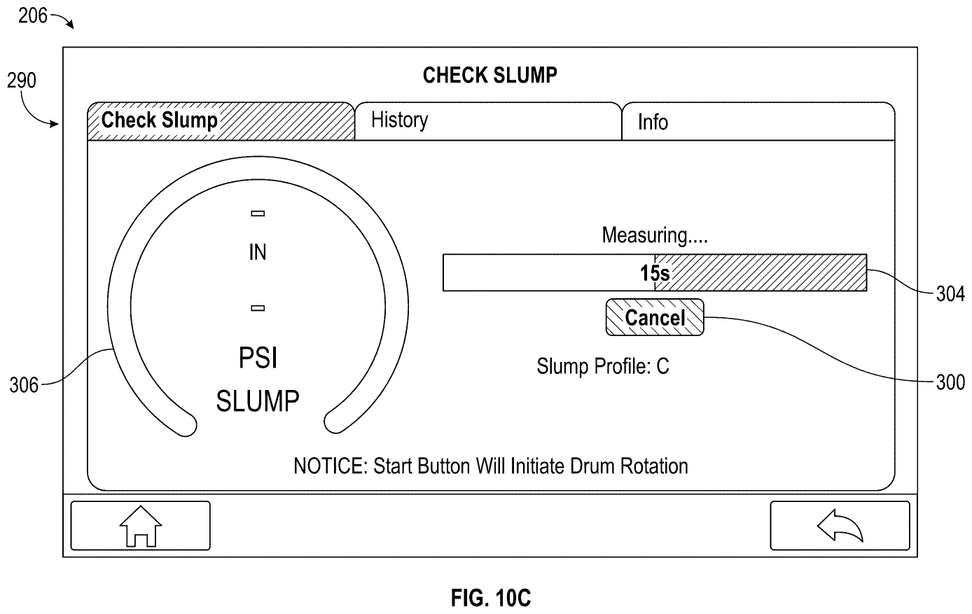

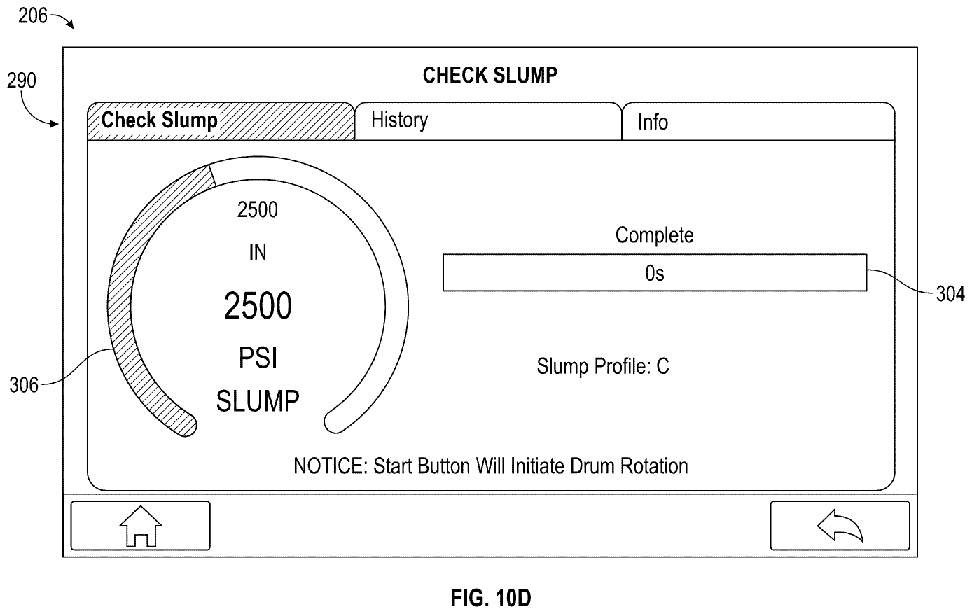

In general, the controller 202 is configured to receive an initiate command and autonomously control the concrete mixer truck 10 to perform a slump check procedure. In some embodiments, the user interface 206 includes a display or touch screen that a user may interface with and select various menu or button options to perform specific tasks or view stored information. For example, the user interface 206 may include a start button (see, e.g., FIG. 10A) that a user may press to active a slump check procedure. In some embodiments, the start button is disabled, which prevents the slump check procedure from being initiated, if an interlock criteria is not met. In other words, prior to initiating the slump check procedure, the controller 202 is configured to verify, via the one or more interlocks 208, that the interlock criteria is met.

In some embodiments, the interlocks 208 may be in the form of a sensor, a signal received from a sensor, and/or a status indicator. For example, the interlocks 208 may include an indication that a parking brake is on or active, which is received from a parking brake sensor (e.g., a switch, a position sensor, etc.). The interlocks 208 may include an indication that a transmission coupled to the engine 74 is in neutral, which is received from a transmission control module or a sensor of the transmission. The interlocks 208 may include an indication that a speed of the engine 74 is within a predetermined speed range (e.g., within predetermined tolerance of an engine idle speed, less than a predetermined speed, or at an idle speed), which is received from an engine speed sensor (e.g., an encoder, etc.). In some embodiments, the speed of the engine 74 is not one of the interlocks 208 and, instead, the slump check procedure includes a step that autonomously sets the engine 74 to an idle speed prior to measuring the slump.

The interlocks 208 may include an indication that the concrete mixer truck 10 is not in motion or stationary, which is received from a speed sensor that is coupled to one or more of the wheels 4, or the transmission of the drive system 20. In some embodiments, the interlocks 208 include an indication that one or more operating modes of the concrete mixer truck 10 are inactive. For example, the interlocks 208 may include an indication that a load mode of the concrete mixer truck 10 (e.g., a mode where the drum is controlled based on a concrete load within the mixing drum 14) is inactive, which is received from a control panel or button within the cab 18 or from the user interface 206. The interlocks 208 may include an indication that a scale mode of the concrete mixer truck 10 is inactive (e.g., a mode where the drum is controlled so that the concrete load is weighted), which is received from a control panel or button within the cab 18 or from the user interface 206. The interlocks 208 may include an indication that fluid temperatures on the concrete mixer vehicle 10 (e.g., hydraulic temperatures, water temperatures, refrigerant temperatures, air temperatures, etc.) are within predetermined operating ranges. Each of the fluid temperatures may be measured by a temperature sensor, which is in communication with the controller 202, and the controller 202 may determine if the fluid temperature is within the predetermined operating range. The interlocks 208 may include an indication that a fault code status is inactive. In other words, no fault codes are active on the concrete mixer truck 10.

In some embodiments, the controller 202 requires all of the interlocks 208 to be satisfied prior to enabling the slump check procedure (e.g., by activating a start button on the user interface 206). For example, the interlocks 208 include: the parking brake is on; the transmission is in neutral; the speed of the engine 74 is within the predetermined speed range; the concrete mixer truck 10 is not moving or is stationary; the load mode is inactive; the scale mode is inactive; the fluid temperatures are within the predetermined operating ranges; and there are no active faults. Once the controller 202 determines that the interlocks 208 are satisfied, the slump check procedure may be initiated via the user interface 206 (e.g., by pressing a start button).

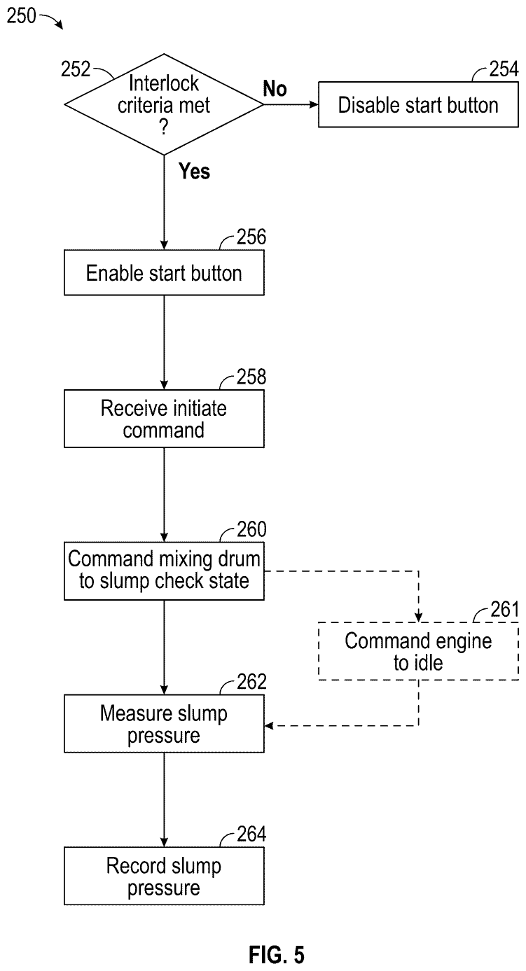

An exemplary embodiment of the steps in a slump check procedure or method 250 is shown in FIG. 5. The slump check procedure 250 will be described with reference to FIGS. 4 and 5. In some embodiments, the steps of the slump check procedure 250 are performed via the controller 202. As described above, the slump check procedure 250 may initiate by determining, at step 252, if the interlock criteria is met. In some embodiments, the controller 202 determines if each of the interlocks 208 are satisfied. If the interlock criteria is not met, a start button on the user interface 206 is disabled at step 254. If the interlock criteria is met, the start button is enabled on the user interface 206 at step 256. With the start button enabled, a user may selectively active (e.g., press) the start button on the user interface 206, which sends an initiate command to the controller 202. Once the initiate command is received by the controller 202 at step 258, the mixing drum 14 is commanded to a slump check state at step 260.

In general, the slump check state defines a constant and repeatable state for the mixing drum 14 that is autonomously commanded by the controller 202. As described herein, in some embodiments, the drum drive motor 130 is in the form of a hydraulic motor. In these embodiments, the drum drive motor 130 is supplied with hydraulic fluid (e.g., oil) from the drum drive pump 204 to power the drum drive motor 130 and rotate the mixing drum 14. To achieve the slump check state, the drum drive pump 204 is commanded, by the controller 202, to a predetermined displacement (e.g., a percent displacement and flow out of the drum drive pump 204). Additionally, the drum drive motor 130 is commanded, by the controller 202, to a predetermined displacement (e.g., a percent displacement). In some embodiments, the predetermined displacement of the drum drive pump 204 is the same as the predetermined displacement of the drum drive motor 130. In some embodiments, the predetermined displacement of the drum drive pump 204 is different than the predetermined displacement of the drum drive motor 130. In some embodiments, the predetermined displacement of the drum drive pump 204 is a maximum displacement (e.g., 100%), and the predetermined displacement of the drum drive motor 130 is a maximum displacement (e.g., 100%). In some embodiments, the predetermined displacement of the drum drive pump 204 is less than a maximum displacement (e.g., between about 100% and about 90%, between about 90% and about 80%, between about 80% and about 70%, between about 70% and about 60%, between about 60% and about 50%, between about 50% and about 40%, between about 40% and about 30%, between about 30% and about 20%, between about 20% and about 10%, between about 10% and about 1%,) and the predetermined displacement of the drum drive motor 130 is less than a maximum displacement (e.g., between about 100% and about 90%, between about 90% and about 80%, between about 80% and about 70%, between about 70% and about 60%, between about 60% and about 50%, between about 50% and about 40%, between about 40% and about 30%, between about 30% and about 20%, between about 20% and about 10%, between about 10% and about 1%).

In some embodiments, during operation, the drum drive motor 130 is set to the maximum displacement by default and then the displacement is controlled down to increase the rotational speed of the mixing drum 14. For example, at the lowest drum speed, the drum drive motor 130 is set to the maximum displacement and the drum drive pump 204 is set to a low displacement (e.g., 2%). The displacement of the drum drive pump 204 is then incrementally increased, with the drum drive motor 130 still at the maximum displacement, to increase the rotational speed of the mixing drum 14 until the drum drive pump 204 reaches its maximum displacement. Once the drum drive pump 204 reaches its maximum displacement, the displacement of the drum drive motor 130 is then reduced to continue increasing the rotational speed of the mixing drum 14 until the mixing drum 14 reaches its maximum rotational speed.

Accordingly, changing the displacement of both the drum drive motor 130 and the drum drive pump 204 may affect the rotational speed of the mixing drum 14, and autonomously setting the displacement of both the drum drive motor 130 and the drum drive pump 204, via the controller 202, to the predetermined displacement creates a repeatable and constant state for the mixing drum 14 at which the slump is measured.

As described herein, in some embodiments, the drum drive motor 130 may be an electric motor. In these embodiments, the drum drive motor 130 may be powered by a battery or a battery pack on board the concrete mixer truck 10. To achieve the slump check state, the drum drive motor 130 may be set to a constant and repeatable state, like in the hydraulic configuration, by supplying a predetermined amount of current or power to the drum drive motor 130 or by commanding the drum drive motor 130 to output a predetermined amount of torque.

In some embodiments, the engine 74 is set to idle, if not already at idle as part of the interlocks 208, as part of the slump check state, as indicated at step 261. Regardless of how the slump check state is achieved, once the controller 202 commands the mixing drum 14 to the slump check state at step 260, the controller 202 measures the slump via the slump sensor 210 at step 262. In some embodiments, the slump sensor 210 is a pressure sensor that measures a pressure required to rotate the mixing drum 14, which is correlated with the slump of the mixture within the mixing drum 14. In some embodiments, the controller 202 may read the pressure measured by the slump sensor 210 for a predetermined amount of time and the average pressure during the predetermined amount of time may be recorded at step 264. In some embodiments, the controller 202 may read the pressure measured by the slump sensor for a predetermined amount of time and then average the pressure values that occur over an average duration within the predetermined amount of time. In some embodiments, the average duration is less than the predetermined amount of time. In some embodiments, the average duration occurs at the end of the predetermined amount of time (e.g., the pressure is measured for an initial duration and then averaged over the remaining duration of the predetermined amount of time and the averaged value is used as the slump value). In some embodiments, the averaged value that is used to calculate the slump is multiplied by a correction factor (e.g., about 1, between about 1 and about 2, or between about 1 and about 5). In some embodiments, the slump value may be recorded in a history screen on the user interface 206 and displayed on a check slump screen on the user interface 206. The slump check procedure 250 provides a repeatable and consistent slump measurement that is autonomously controlled, efficiently initiated (e.g., with the press of a button), and not subject to operator error.

In some embodiments, the slump value that is measured, recorded, and displayed during the slump check procedure 250 is a pressure value (e.g., in pounds per square inch). In some embodiments, the slump value that is measured, recorded, and displayed during the slump check procedure is a pressure value and a inches of slump. In some embodiments, the user interface 206 includes a slump meter table that a user, or a cloud-based server, may populate to correlate pressure values, which are measured by the slump sensor 210, to a slump value in inches. If this slump meter table is populated, then the controller 202 is configured to instruct the user interface 206 to display the slump value in inches, or both in a pressure value and a value in inches.

In some embodiments, if any one of the interlocks 208, or another action, is commanded (e.g., the interlock criteria is not met or another function is commanded) during the slump check procedure 250, the slump check procedure 250 will stop, record a failed event, and the commanded action will take priority and the concrete mixer vehicle 10 will operate according to the commanded action. In some embodiments, the commanded action that will stop the slump check procedure 250 and record a failed slump check includes at least one of: a parking brake is released, a throttle pedal is engaged, a load-span tag axle is commanded up or down, a drum stop is commanded, a drum pause is commanded, a drum mix mode is commanded, a load mode is commanded, a drum transport mode is commanded, the engine 74 is commanded to high idle, a force regen is commanded, an ignition is key cycled, a water add button is commanded, a drum speed change is commanded, any drum pressure/speed faults become active, any motor/pump displacement faults become active.

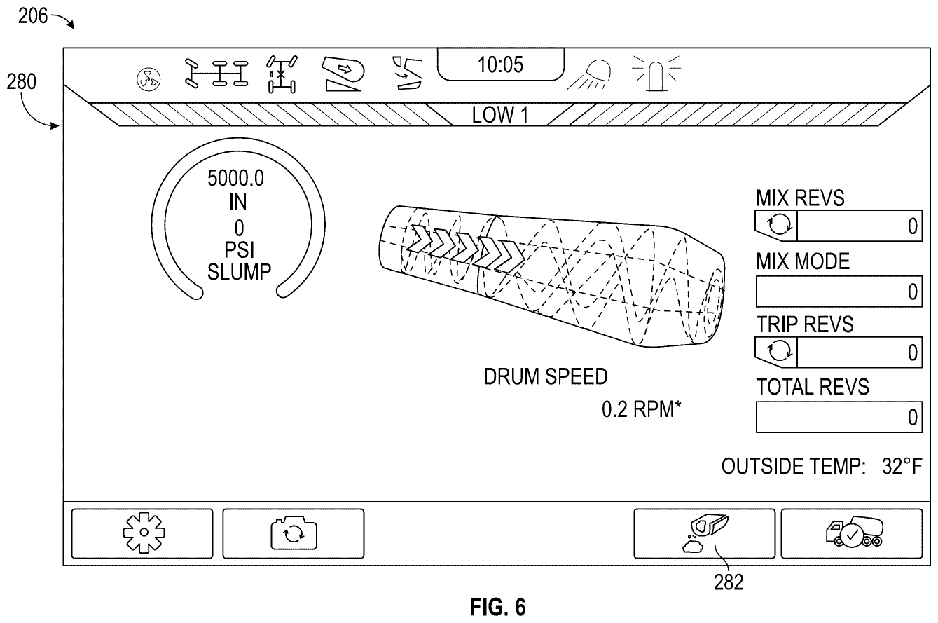

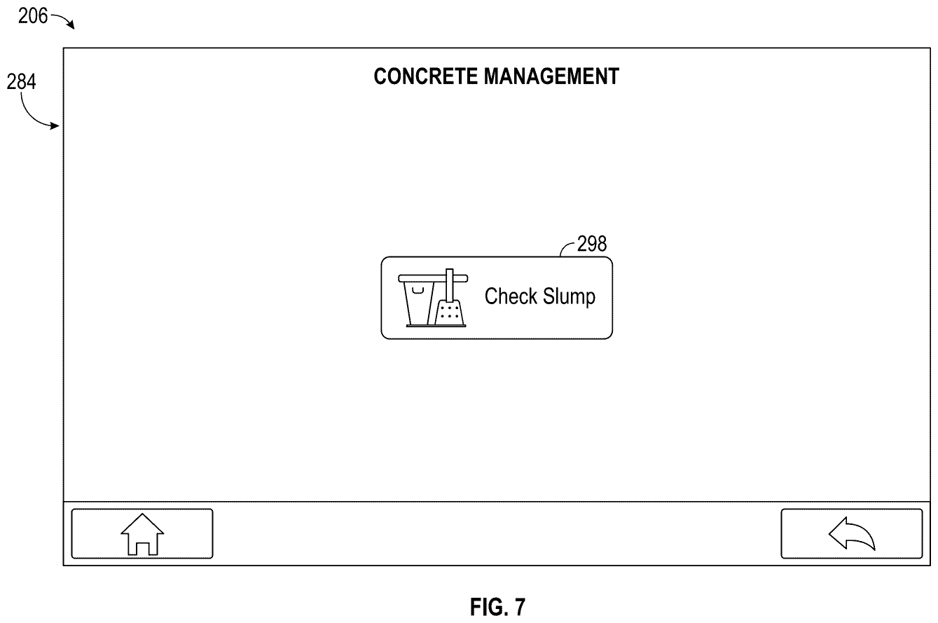

FIGS. 6-11 illustrate an exemplary embodiment of the user interface 206 and the various screens accessible via the user interface 206. For example, FIG. 6 illustrates a home screen 280 of the user interface 206. The home screen 280 includes dials, indictors, buttons, and illustrations to represent various operational parameters of the concrete mixing truck 10 (e.g., slump, mixing drum revolutions, etc.). Specifically, the home screen 280 includes a concrete management button 282 that, when pressed, transitions the user interface 206 to a concrete management screen 284 (see, e.g., FIG. 7). On the concrete management screen 284, there is a check slump button 288. In some embodiments, if the concrete mixer truck 10 includes a water meter, the concrete management screen 284 may include an add water button on the concrete management screen 284.

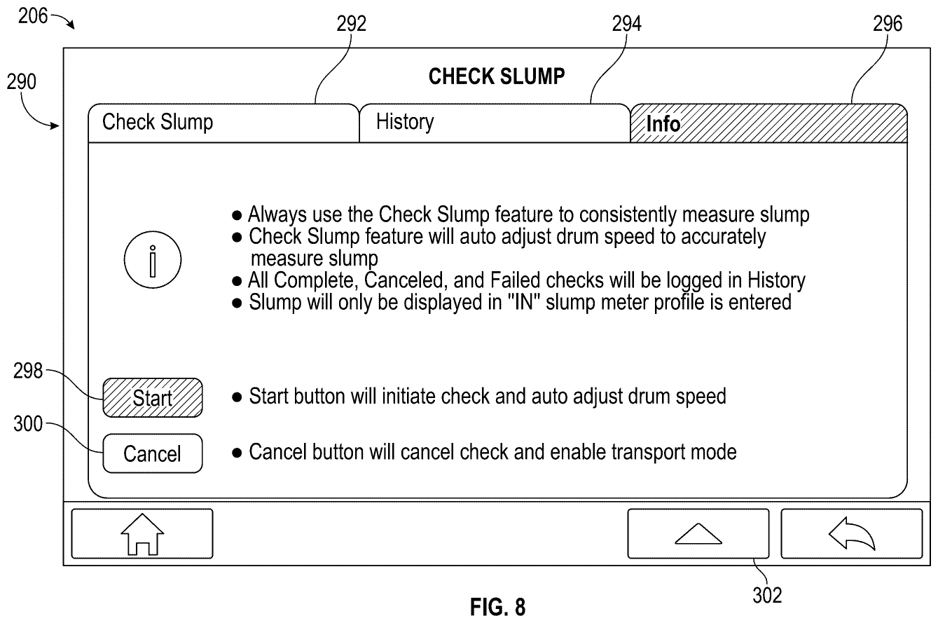

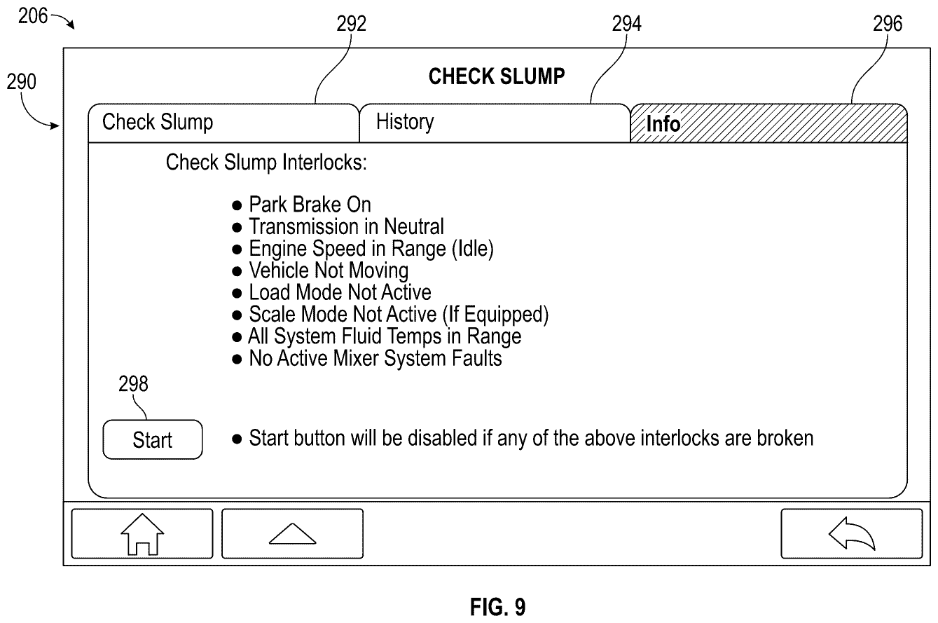

Once the check slump button 288 is pressed, the user interface 206 transitions to a check slump screen 290. The check slump screen 290 includes a check slump tab 292, a history tab 294, and an information tab 296. The information tab 296 is illustrated in FIGS. 8 and 9. As illustrated in FIG. 8, the information tab 296 displays information about the slump check procedure 250 and includes a start button 298 and a cancel button 300. The start button 298 is configured to generate the initiate command and start the slump check procedure 250. As described herein, the start button 298 may only be active if the interlock criteria is met. The cancel button 300 is configured to stop an in-process slump check procedure.

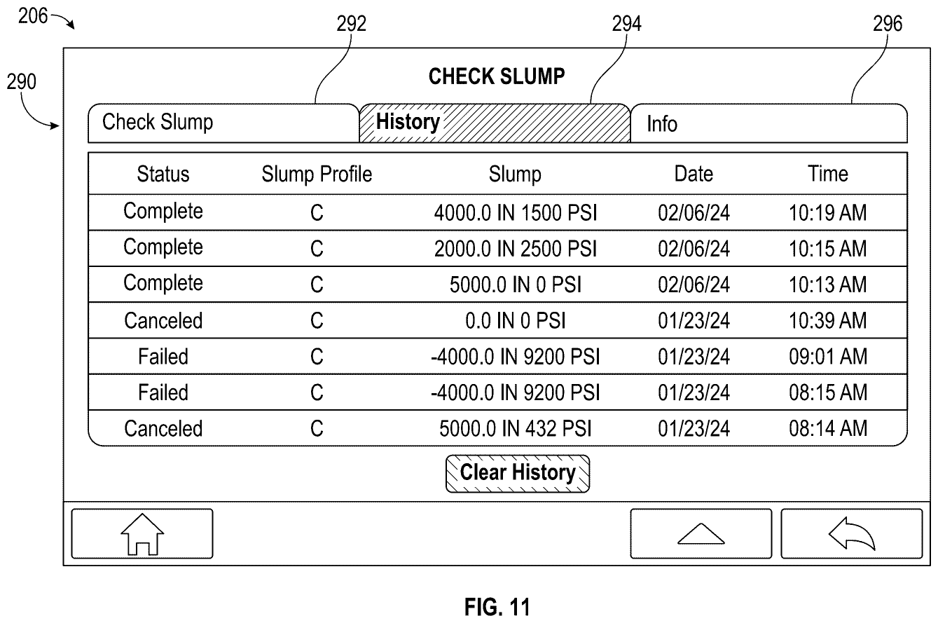

FIG. 9 shows a secondary screen on the information tab 296, which may be navigated to by pressing the down arrow 302. On the secondary screen, the interlocks 208 are listed and the start button 298 is located below the list of interlocks 208. As shown in FIGS. 10A-D, the check slump screen 290 includes the start button 298, a status bar 304 that counts down a time for the slump check procedure 250, and a dial indicator 306 that displays the slump measurement after the slump check procedure 250 is completed (see, e.g., FIG. 10D). Once the slump check procedure begins, the start button 298 transitions to the cancel button 300 and the status bar 304 begins counting down the time until the slump check procedure is done. Once the slump check procedure is completed, the slump measurement is displayed on the dial indicator 305 and the slump measurement (and previous slump measurements) is stored on the history tab 294, as shown in FIG. 11.

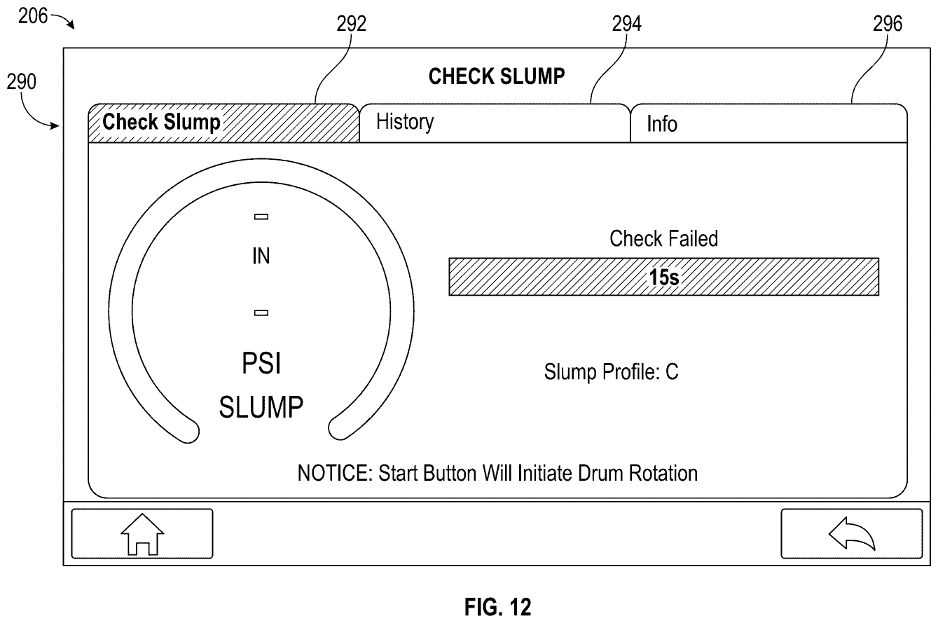

As described herein, if a particular commanded action occurs during an active slump check procedure 250, the slump check procedure 250 will stop and record a failed slump check. This failed slump check is show in the check slump tab 292 of the check slump screen 290, as shown in FIG. 12.

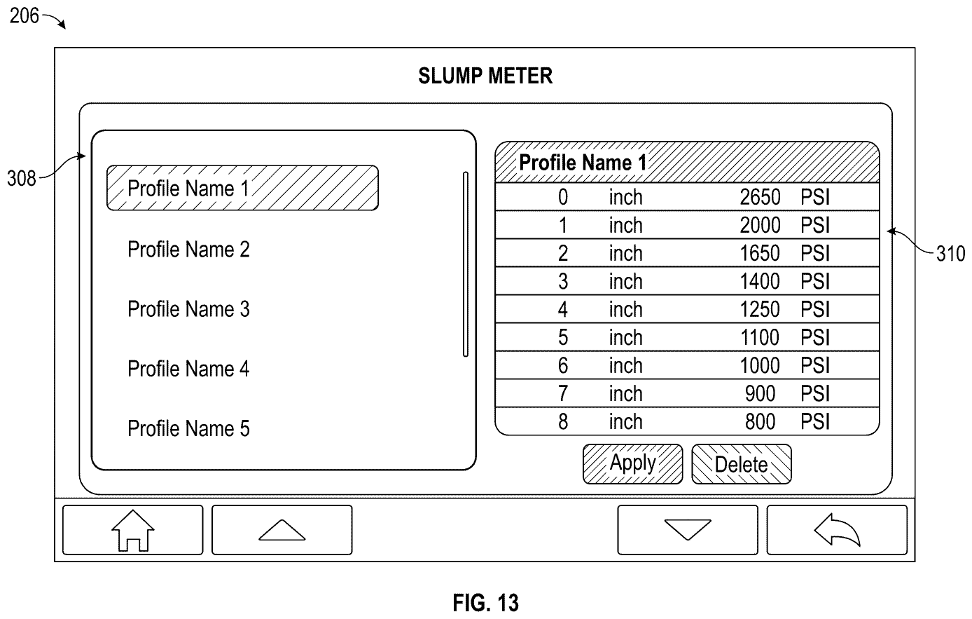

FIG. 13 shows an exemplary embodiment of a slump meter screen 308 of the user interface 206 where a user may input values to a slump meter table 310 to correlate pressure values measured by the slump sensor 210 to inches of slump.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the mixer vehicle 10 and the control system 200 as shown in the various exemplary embodiments is illustrative only. Additionally, any element disclosed in one embodiment may be incorporated or utilized with any other embodiment disclosed herein.

What is claimed is:

1. A concrete mixer truck, comprising:
a chassis;
an engine supported on the chassis;
a mixing drum supported on the chassis;
a motor configured to rotate the mixing drum;
a slump sensor configured to measure a pressure correlated with a slump of a mixture within the mixing drum; and
a controller in communication with the engine, the motor, and the slump sensor, the controller being configured to:
verify an interlock criteria is satisfied;
receive an initiate command for a slump check procedure;
in response to receiving the initiate command, command the motor to a slump check state;
measure the pressure from the slump sensor for a predetermined amount of time; and
calculate a slump value based on the pressure measured by the slump sensor.

2. The concrete mixer truck of claim 1, further comprising a user interface.

3. The concrete mixer truck of claim 2, wherein the user interface includes a history screen where previous slump values are recorded and displayed.

4. The concrete mixer truck of claim 2, wherein the initiate command is generated by activation of a start button on the user interface.

5. The concrete mixer truck of claim 4, wherein the start button is disabled if the interlock criteria is not satisfied.

6. The concrete mixer truck of claim 1, further comprising a drum drive pump configured to supply pressurized fluid to the motor.

7. The concrete mixer truck of claim 6, wherein the slump check state includes commanding both the drum drive pump and the motor to a predetermined displacement.

8. The concrete mixer truck of claim 7, wherein the predetermined displacement is a maximum displacement.

9. The concrete mixer truck of claim 1, wherein the slump value is calculated by averaging the pressure measured by the slump sensor over the predetermined amount of time.

10. The concrete mixer truck of claim 1, wherein the slump value is calculated by averaging the pressure measured by the slump sensor over the predetermined amount of time and multiplying the average by a correction factor.

11. The concrete mixer truck of claim 1, wherein the controller is configured to stop the slump check procedure in response to a commanded action being received during the slump check procedure.

12. The concrete mixer truck of claim 11, wherein the commanded action includes at least one of: a parking brake is released, a throttle pedal is engaged, a load-span tag axle is commanded up or down, a drum stop is commanded, a drum pause is commanded, a drum mix mode is commanded, a load mode is commanded, a drum transport mode is commanded, the engine is commanded to high idle, a force regen is commanded, an ignition is key cycled, a water add button is commanded, a drum speed change is commanded, or a fault code is issued.

13. The concrete mixer truck of claim 1, further comprising a user interface, wherein the slump value is displayed on the user interface.

14. A concrete mixer truck, comprising:
a chassis;
an engine supported on the chassis;
a mixing drum supported on the chassis;
a motor configured to rotate the mixing drum;
a slump sensor configured to measure a pressure correlated with a slump of a mixture within the mixing drum;
a user interface; and
a controller in communication with the engine, the motor, the slump sensor, and the user interface, the controller being configured to:
receive an initiate command from the user interface for a slump check procedure;
verify an interlock criteria is satisfied;
in response to the interlock criteria being satisfied, initiate the slump check procedure and command the motor to a slump check state;
average the pressure from the slump sensor for a predetermined amount of time; and
calculate a slump value based on the average of the pressure measured by the slump sensor.

15. The concrete mixer truck of claim 14, wherein the initiate command is generated by activation of a start button on the user interface, wherein the start button is disabled if the interlock criteria is not satisfied.

16. The concrete mixer truck of claim 14, further comprising a drum drive pump configured to supply pressurized fluid to the motor, wherein the slump check state includes commanding both the drum drive pump and the motor to a predetermined displacement.

17. The concrete mixer truck of claim 14, wherein the user interface includes a history screen where previous slump values are recorded and displayed.

18. The concrete mixer truck of claim 14, wherein the controller is configured to stop the slump check procedure in response to a commanded action being received during the slump check procedure.

19. The concrete mixer truck of claim 18, wherein the commanded action includes at least one of: a parking brake is released, a throttle pedal is engaged, a load-span tag axle is commanded up or down, a drum stop is commanded, a drum pause is commanded, a drum mix mode is commanded, a load mode is commanded, a drum transport mode is commanded, the engine is commanded to high idle, a force regen is commanded, an ignition is key cycled, a water add button is commanded, a drum speed change is commanded, or a fault code.

20. A method for an autonomous slump check procedure on a concrete mixer truck, the method comprising:
receiving, from a user interface, an initiate command;
verifying an interlock criteria is satisfied; and
in response to verifying that the interlock criteria is satisfied, initiating a slump check procedure by:
commanding a motor to a slump check state;
averaging a pressure from a slump sensor for a predetermined amount of time; and
calculating a slump value based on the average of the pressure measured by the slump sensor over the predetermined amount of time.
